(19) United States
(12) Patent Application Publication
(10) Pub. No.: US 2013/0021139 A1
(43) Pub. Date: Jan. 24, 2013

(54) OPERATION METHOD FOR MOBILE INFORMATION TRANSMISSION SYSTEMS

(71) Applicant: Dau-Ning GUO, New Taipei City (TW)

(72) Inventor: Dau-Ning GUO, New Taipei City (TW)

(21) Appl. No.: 13/530,982

(22) Filed: Jun. 22, 2012

(30) Foreign Application Priority Data
Jul. 19, 2011 (TW) 100125383

(51) Int. Cl. G06K 7/01

(52) U.S. Cl. 340/10.1

(57) ABSTRACT

An operation method for a mobile information transmission system allows an information provider in a selected area to provide a first data to a user. The system includes a first RFID device and a first networking device controlled by the information provider, a second RFID device and a second networking device carried by the user, and a server linking to the first networking device and second networking device respectively. The user reads a first identification code of the first RFID device via the second RFID device, then uploads to the server via the web; next, the server transmits the first data provided by the information provider in a first web space to a second web space of the user for information exchange. Thus information broadcasting scale of the RFID can be expanded to improve information exchange between people.

### FIELD OF THE INVENTION

The present invention relates to an information transmission system and particularly to an operation method for mobile information transmission systems that is triggered via Radio Frequency Identification technique.

### BACKGROUND OF THE INVENTION

Radio Frequency Identification (RFID in short hereinafter) generally is a system integrating and linking a RFID reader, a RFID sensor and a software system together. Its operation principle: the RFID reader emits a radio signal of a specific frequency to the RFID sensor to drive a circuit inside to send data in a chip back to the RFID reader. The RFID sensor includes a RFID tag, a RFID card and a RFID ring. The RFID tag is attached to an article. Through one set of reader merchandises in a warehouse or store can be managed and tracked to control inventory and check whether expiration date is due. It also can be attached to a coin or debit card to provide antifraud function. It also is adoptable to other goods, such as luggage, mails, packages, pharmaceuticals, valuable bills and the like. Once they have a RFID tag attached, their whereabouts can be tracked.

The applications of RFID have features as follow:

1. It is non-contact automatic sensing. Unlike the conventional magnetic stripe or computer barcodes that have to be in direct contact with a reader, it can read multiple pieces at the same time to save manpower when a great number of goods have to be processed. In addition, reading of RFID can be integrated into operation process to read data in an unperceivable scenario, hence can reduce operation complexity and improve productivity. After the RFID data has been automatically detected, the rear end processing system can perform downstream process according to a preset design, such as an automatic identification mechanism, rule verification, error prevention and alert, or the like. Therefore RFID applications are more flexible and extensive.

2. Article status recording. RFID tag can be attached to various types of goods, people, vehicles or the like. The application systems can instantly and automatically update article status to provide tracking and management function. Moreover, to match positioning requirements, RFID also can provide instant tracking based on the read location records.

3. Data information storage. Some types of RFID can be repeatedly read and written and reused. Its memory can save vital data information of the article. The data information also are moved with movement of the article, thus provide data portability.

Take manufacture industry for instance. Dell has production lines in China that employ RFID to improve production efficiency. International Paper uses RFID in the warehouse management system to track the locations of finished goods in the warehouse. KTP Trendtar provides a RFID solution to manage transportation and container management for chemicals and gas shipment. In automobile industry, vehicle manufacturers, such as Ford, Toyota, Mazda, Volkswagen and the like have actively implemented RFID projects in management of assets and supply chains. Some others track tires through RFID. Goodyear and Michelin have RFID embedded in the tires with the RFID tag recording information such as manufacturing date, production site, purchase date and the like, and use the only identification code on the tire linked to the vehicle identification code for tracking, and can further access the tire pressure information for monitoring.

RFID also is used in retail business, not only includes retail stores and smart shelf applications, also covers other applications, such as Point-of-sale (POS) on retail stores and enterprise logistics center system, supply chain rear end, closed type inventory management system and the like. Europe's Mark & Spencer uses RFID sensors to track 3.5 millions of pallets, and also adopts an architecture set up by EPCglobal to test Item-level RFID tracking to get better understanding of the benefits of inventory tracking and management. Carrefour and Metro also are actively doing related tests of RFID in supply chain management. In apparel retail applications, Benetton and Gap have attached RFID tags on garments to allocate retail apparels and reduce excessive inventory. Some others have focused solutions in retail security, for instance, Tyco is developing RFID antitheft and Item-level tracking applications.

In transportation industry, RFID had been adopted in many applications areas, such as access control, asset management, Real-time positioning system, luggage and package processing, Container-level supply chain management, Item-level supply chain management, automatic vehicle identification, tire tracking and the like. Among them, online reservation system, automatic vehicle identification and asset management are most notable applications at present. Logistics companies, such as DHL, FedEX, UPS and the like, are actively using RFID technique in their logistics operation systems. CHEP, which is a global leader in logistics management of pallets and containers, has completed related tests of RFID applications, and expects to provide management experiences regarding retail and industry supply chain, cross-industry and cross-application Container-level RFID. Delta Airline also is trying to use RFID to track luggage, and has finished related tests.

In pharmaceuticals, in view of RFID can provide effective tracking function, major pharmaceutical companies in the U.S. have employed RFID in pharmaceutical packages to guard against frauds. For instance, each bottle of Viagra package has attached a passive high frequency (13.56 MHz) sensor, and Pfizer pharmaceutical corporation has integrated sensor applications and certifying programs for the Viagra sold in the U.S. U.S. Purdue pharmaceutical company has implemented a test plan to improve distribution safety of prescription drugs from the plants to the distributors, and through a tracking and monitoring pharmaceutical system to make dispensing of drugs more reliable. A RFID tag embedded with an ePedigree technique is attached beneath the bottle label of pain-killer before delivery to the pharmaceutical wholesales group H.D. Smith. Upon receiving the medicines, it signs off via numerical codes to confirm the pedigree data and issues approval certificate to ensure that each bottle of medicine matches a corresponding serial number on the RFID sensor. Osborne Park hospital in Australia also uses RFID on identification control of new born babies.

Application number of RFID cards in Japan has grown exponentially. More than ten thousands of stores have installed RFID readers on the cash registers to accept payment of RFID cards or RFID handsets. Toppan Forms, one of the biggest RFID card producers, has expanded one factory to double card production to meet growing market requirements. This year sales of RFID handsets in Japan could reach 47-50 millions. These RFID handsets not only can be used on retail sales payments, also can make payment of public transportation fares. In South Korea, the RFID card of T-money can be used to make payment of public transportation fares. Moreover, most convenience stores and subway vending machines can accept payment of T-money.

However, in the conventional techniques, such as U.S. patent publication No. US 2011/0068925, the function of RFID sensor mainly focuses on identification of commodities, and the transmitted data merely limited to identification of data prewritten into the RFID sensor. There are still rooms for improvement.

### SUMMARY OF THE INVENTION

The primary object of the present invention is to use RFID as a trigger of information transmission taking place between web pages to increase information transmission scale.

To achieve the foregoing object the invention provides an operation method for mobile information transmission systems to allow an information provider within a selected area to provide a first data to a user. The system includes a first RFID device and a first networking device controlled by the information provider, a second RFID device and a second networking device carried by the user, and a server linking to the first networking device and second networking device respectively. The information provider and user have respectively authority to access a first web space and a second web space in the server. The method comprises the steps as follow:

Step 1: The information provider enters the first web space through the first networking device and edits a first data in the first web space;

Step 2: After the second RFID device is moved with the user in the selected area where the first RFID device is located, the second radio frequency identification device reads and decodes a first identification code (ID code in short hereinafter) sent from the first RFID device; and

Step 3: The user enters the first web space via the second networking device through the first ID code to get the first data.

By means of the method set forth above, the first RFID device, first networking device, second RFID device, second networking device and server jointly form a mobile information transmission system, and through operation of the mobile information transmission system people can establish information exchange between them, and through the inherent characteristics of the RFID device instant and local information broadcasting can be accomplished.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the invention.

FIG. 2 is a schematic view of the block diagram of a first embodiment of the invention.

FIG. 3 is a schematic view of the block diagram of a second embodiment of the invention.

### DETAILED DESCRIPTION OF THE PREFERRED EMBODIMENTS

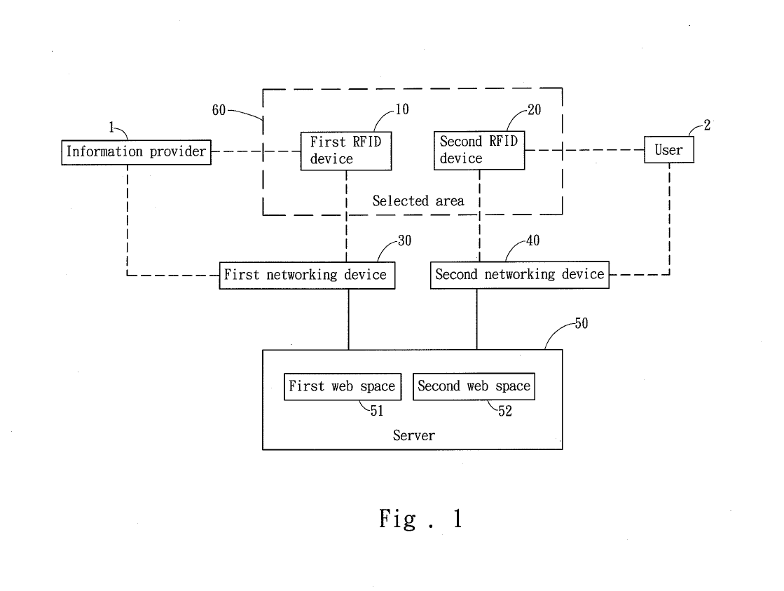

Please refer to FIG. 1 for a block diagram of the invention. The present invention aims to provide an operation method for a mobile information transmission system to allow an information provider 1 within a selected area 60 to provide a first data to a user 2. The system includes a first RFID device 10 and a first networking device 30 controlled by the information provider 1, a second RFID device 20 and a second networking device 40 carried by the user 2, and a server 50 linking to the first networking device 30 and second networking device 40 respectively to establish network connection. The information provider 1 and the user 2 have respectively authority to access a first web space 51 and a second web space 52 in the server 50. The method comprises the following steps:

Step 1: The information provider 1 enters the first web space 51 through the first networking device 30 and edits a first data in the first web space 51;

Step 2: The second RFID device 20 is moved with the user 2 in the selected area 60 where the first RFID device 10 is located, then reads and decodes a first ID code sent from the first RFID device 10; and

Step 3: The user 2 enters the first web space 51 via the second networking device 40 through the first ID code to get the first data and browse the first data in the second web space 52.

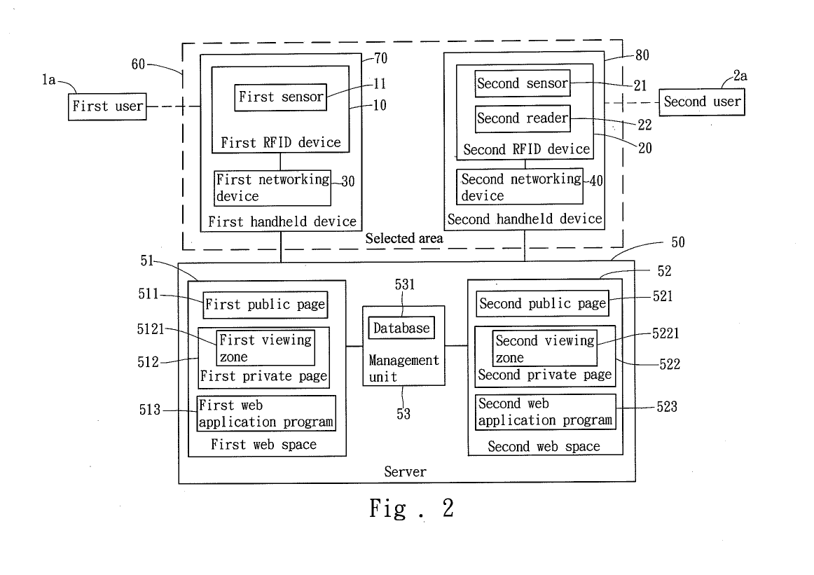

Depending on different use scenarios different operation modes are provided. Please refer to FIG. 2 for the block diagram of a first embodiment of the invention. In this embodiment the invention is used between a first user 1a and a second user 2a. The mobile information transmission system includes a first RFID device 10 and a first networking device 30 on a first handheld device 70 that are controlled by the first user 1a, a second RFID device 20 and a second networking device 40 on a second handheld device 80 that are controlled by the second user 2a, and a server 50 linking to the first networking device 30 and second networking device 40 respectively. The first RFID device 10 includes a first sensor 11 having a first identification code (ID code in short hereafter) and a first activation code obtained through a hash function operation of the first ID code. The second RFID device 20 includes a second sensor 21 and a second reader 22 having a second ID code and a second activation code obtained through a hash function operation of the second ID code. The server 50 includes a first web space 51, a second web space 52 and a management unit 53 linking the first web space 51 and second web space 52. The first web space 51 includes a first public page 511, a first private page 512 contained a first viewing zone 5121 and a first web application program 513. The second web space 52 includes a second public page 521, a second private page 522 contained a second viewing zone 5221 and a second web application program 523. The management unit 53 includes a database 531.

When in operation, first, the first user 1a and second user 2a are connected respectively to the server 50 via the first networking device 30 and second networking device 40, and get respectively use authority of the first web space 51 and second web space 52 from the server 50 via the first activation code and second activation code; the server 50 relates the first ID code with the first web space 51, and saves them in the database 531.

The first user 1a can edit a first public data on the first public page 511, such as to create link to the blog web address, brief self introduction, or other web link and information intended for sharing, and also edit a first private data on the first private page 512, such as name, birthday, e-mail address or social group web account and the like.

When the first user 1a and second user 2a carry respectively the first handheld device 70 and second handheld device 80 in the selected area 60, the second reader 22 reads and decodes the first ID code sent from the first sensor 11 and detects a signal intensity value from the first sensor 11.

The second networking device 40 decodes the first ID code and retrieves the signal intensity value, and uploads to the second web application program 523. Then the second web application program 523 sends the first ID code to the management unit 53 which searches the corresponding relationship between the first web space 51 and the first ID code, then the management unit 53 transmits the first public data edited by the first user 1a on the first public page 511 to the second private page 522 of the second user 2a, and also shows in the second viewing zone 5221. Thereby the first user 1a carrying the first RFID device 10 can easily share information with the second user 2a who carries the second RFID device 20 in the neighborhood.

Furthermore, in the event that the second user 2a wants to exchange information with the first user 1a, the second users 2a can send an exchange invitation message (first message) via the second web application program 523 and database 531 of the server 50 to the first user 1a, and display the message in the first viewing zone 5121 of the first private page 512; next, the first user 1a can send an “accept” response message (second message) via the first web application program 513 to the second viewing zone 5221 of the second private page 522; therefore the first user 1a and second user 2a can exchange private data, such as name, birthday, e-mail or social group web site account via the first web application program 513 and second web application program 523.

It is to be noted that the second web application program 523 also provides data filter function, through which the second users 2a can set preferred information types to filter the first public data sent to the second private page 522. In addition, the second user 2a also can set open or close function for receiving the first public data through the second web application program 523. Similarly, the first user 1a also can set open or close function for sharing the first public data through the first web application program 513.

Moreover, the mobile information transmission system can include other RFID devices. Hence the second reader 22 may simultaneously read other ID codes sent by the other RFID devices. How to effectively read those ID codes at the same time and display on the second viewing zone 5221 will affect performance of the invention. Hence the second networking device 40 also decodes the first ID code and signal intensity value and uploads to the second web application program 523, and performs ID code process as follow:

a. The second web application program 523 retrieves the first ID code and signal intensity value from data receiving queue in a first in first out manner;

b. The second web application program 523 compares the signal intensity value with a threshold value set by the second user 2a; in the event that the signal intensity value is smaller than the threshold value the first ID code is abandoned; otherwise, proceeds step c;

c. The second web application program 523 sends a request to the management unit 53 to get the first public data of the first public page 511 corresponding to the first ID code;

d. The second web application program 523, based on the signal intensity value and data type of the first public page 511 and a newly read flag, calculates a display priority value according to a formula as follow:

Display priority value=Type priority value×Type weight+Signal intensity×signal intensity weight+Newly read flag×Newly read weight

e. According to the calculated display priority value, the first public data is placed in the display queue, those with a higher display priority value displayed at the upper side.

f. Judge whether the first public data is saved, if positive, the first public data is removed from the display queue;

g. Judge whether the display queue is full; if positive, remove the public information of the smallest display priority value from the display queue;

h. Return to step a.

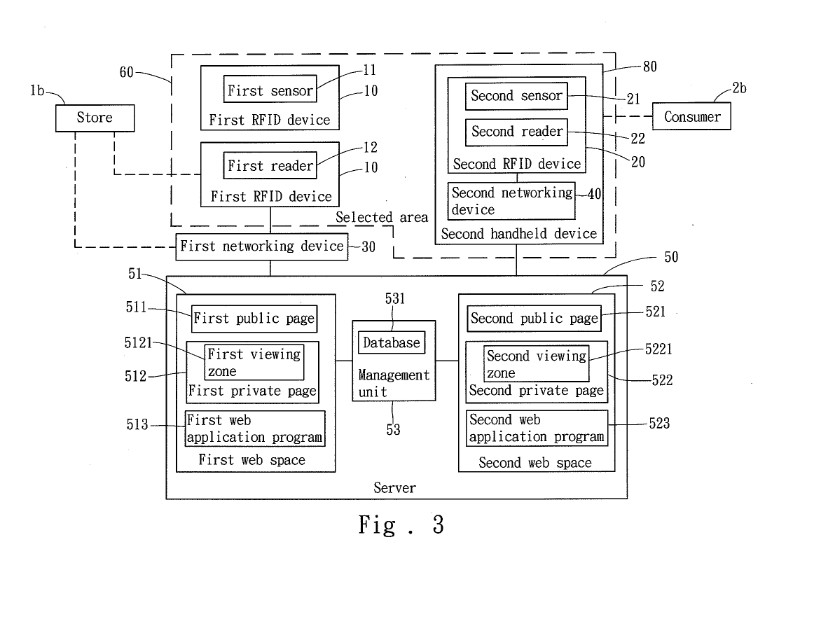

Please refer to FIG. 3 for the block diagram of a second embodiment of the invention. In this embodiment the invention is used between a store 1b and a consumer 2b. The structural configuration is substantially same as the first embodiment. It differs mainly by placing the first RFID device 10 and first networking device 30 not on the same equipment, i.e. the first sensor 11 and first networking device 30 are separated.

When in operation, first, the store 1b and consumer 2b are linked respectively to the server 50 via the first networking device 30 and second networking device 40, and get respectively use authority of the first web space 51 and second web space 52 in the server 50 via the first activation code and second activation code; the server 50 relates the first ID code with the first web space 51 and saves in the database 531.

The store 1b can edit a first public data on the first public page 511, such as introduction of the store 1b, merchandise highlights or link to the blog web address of the store 1b.

When the consumer 2b carries the second handheld device 20 in the selected area 60 where the first sensor 11 of the store 1b is located, the second reader 22 reads and decodes the first ID code sent from the first sensor 11 and detects a signal intensity value of the first sensor 11.

The second networking device 40 decodes the first ID code and retrieves the signal intensity value, and uploads to the second web application program 523. Then the second web application program 523 sends the first ID code to the management unit 53 which searches the corresponding relationship between the first web space 51 and first ID code, then the management unit 53 transmits the first public data edited by the store 1b on the first public page 511 to the second private page 522 of the consumer 2b, and also displays in the second viewing zone 5221. Thereby the store 1b, through the first sensor 11, can easily share information with the consumer 2b who carries the second RFID device 20 in the neighborhood. For instance, the store 1b can install the first sensor 11 on a display rack at the door. When the consumer 2b passes by the display rack, he/she can get detailed information of the merchandises through the second RFID device 20.

Furthermore, the store 1b can install an additional first reader 12 linked to the first networking device 30. The second sensor 21 has a second ID code. Hence when the consumer 2b with the second sensor 21 approaches the first reader 12, the first reader 12 reads and decodes the second ID code, and the first networking device 30 uploads the decoded second ID code to the first web application program 512; through the database 531 in the management unit 53 the first web application program 513 can send an inquiry message of “joining membership” and first public data of the store 1b to the second viewing zone 5221 of the consumer 2b. When the consumer 2b reads the inquiry message of “joining membership”, he/she can send a response of “join” or “not joining” via the second web application program 523. In the event that the response of “join” is made the second web application program 523 of the consumer 2b transmits the second private data, such as name, birthday, e-mail address and the like to the first private page 512 of the store 1b, and saves the data in the member database (first private data) of the store 1b to be edited by the store 1b. Thus the consumer 2b finishes registration process. Afterward, whenever the store 1b has new purchasing information they can be added in the first public page 511, meanwhile, the first web application program 513, based on the membership data of the consumer 2b in the member database, transmits the new purchasing information to the second viewing zone 5221 of the second private page 522 of the consumer 2b. Thereby the consumer 2b can instantly get most updated purchasing information on the second viewing zone 5221.

As a conclusion, the invention, through the first RFID device, first networking device, second RFID device, second networking device and server, forms a mobile information transmission system to establish information exchange between people. Moreover, through the inherent of the RFID devices, instant and local information broadcasting can be accomplished. It is a novel information broadcasting mode. For instance, in public sites such as a public transportation or shopping mall, people who do not know each other before can meet and become acquaintances through the invention, and stores can send promotion and member special sales information via the invention to save the cost of printed commercials or catalogs to achieve the benefit of paperless environmental conservation. It provides significant improvements over the conventional techniques.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An operation method for a mobile information transmission system allowing an information provider to provide a first data to a user within a selected area in which the system including a first radio frequency identification device and a first networking device that are controlled by the information provider, a second radio frequency identification device and a second networking device that are carried by the user and a server linking to the first networking device and the second networking device respectively, the information provider and the user being provided respectively authority to access a first web space and a second web space in the server, the method comprising the steps of:
step 1: entering the first web space by the information provider through the first networking device and editing the first data in the first web space;
step 2: after the second radio frequency identification device moving with the user in the selected area where the first radio frequency identification device is located, the second radio frequency identification device reading and decoding a first identification code sent from the first radio frequency identification device; and
step 3: entering the first web space by the user via the second networking device through the first identification code to get the first data.

2. The operation method of claim 1, wherein the first web space includes a first public page, the first data including a first public data which are edited by the information provider at the step 1 on the first public page.

3. The operation method of claim 2, wherein the first web space includes a first private page, the first data including a first private data which is edited by the information provider on the first private page in a step 1A followed the step 1.

4. The operation method of claim 1, wherein the second web space includes a second public page and a second private page contained a second viewing zone in which the first data is browsable by the user at the step 3.

5. The operation method of claim 1, wherein the second web space includes a second web application program which allows the user to send a first message to the first web space via the server in a step 4 after the step 3 to allow the information provider to receive the first message in the first web space.

6. The operation method of claim 5, wherein the first web space includes a first web application program to allow the information provider to send a second message to the second web space via the server in a step 5 after the step 4 to allow the user to receive the second message in the second web space.

7. The operation method of claim 1, wherein the second radio frequency identification device further detects a signal intensity value of the first radio frequency identification device at the step 2.

8. The operation method of claim 7, wherein the second web space includes a second web application program to receive the first identification code and the signal intensity value sent from the second networking device at the step 3, the second web application program setting a threshold value and registering the first identification code into the first web space via the server when the signal intensity value is not smaller than the threshold value.
